(19) United States
(12) Patent Application Publication
(10) Pub. No.: US 2008/0049667 A1
(43) Pub. Date: Feb. 28, 2008

(54) System For Packet-Error Triggered Control Channel Transmissions

(75) Inventors: Zhigang Rong, San Diego, CA (US); Quanzhong Gao, Shenzhen City (CN)

Correspondence Address: AKIN GUMP STRAUSS HAUER & FELD, LLP, P O BOX 688, DALLAS, TX, 75313-0688, US

(73) Assignees: FUTUREWEI TECHNOLOGIES, INC., Plano, TX (US); Futurewei, Inc. (USA), Plano, TX (US)

(21) Appl. No.: 11/780,311

(22) Filed: Jul. 19, 2007

Related U.S. Application Data
(60) Provisional application No. 60/823,492, filed on Aug. 24, 2006.

(51) Int. Cl. H04Q 7/00

(52) U.S. Cl. 370/329

(57) ABSTRACT

A method to provide timely and accurate control channel information to an Access Network is disclosed to facilitate power control and data packet transmission. Upon receiving a packet error from the Access Network, an Access Terminal transmits a Packet-Error-Triggered (PET) control channel information to the Access Network. The PET control channel information may contain the same type of information as those contained in the regular periodical control channel information. Alternatively, the PET control channel information may contain a different type of information from those contained in the regular periodical control channel information. The PET control channel information may be transmitted using channel gain higher than that used for the regular periodical control channel information to improve its reliability at the Access Network receiver. The PET control channel information can also be utilized to improve the performance of decoding the Reverse Acknowledgement Channel (R-ACKCH).

### PRIORITY CLAIM

This application claims the priority benefit of U.S. Provisional Application No. 60/823,492, filed on Aug. 24, 2006 and entitled “Packet-Error-Triggered Control Channel Transmissions.”

### TECHNICAL FIELD OF THE INVENTION

The present invention generally relates to communication systems, and more particularly, to a system of method and structures for triggering control channel transmissions in a wireless communication system.

### BACKGROUND OF THE INVENTION

In a packet-switching based wireless communication system, a mobile station—sometimes referred to as an Access Terminal (AT) in certain wireless communication systems—transmits control channel information to a base station—such as a receiver for an Access Network (AN)—to allow the base station to optimize the receiver's operating parameters. For example, in a cdma2000 1x EVolution Data Optimized (1xEV-DO) system, Data Rate Control (DRC) information is periodically transmitted from an AT to an AN on Reverse Link. The DRC information carried on a DRC channel indicates packet transmission parameters—such as packet size, packet transmission duration, and preamble length—that the AT would like the AN to utilize when transmitting data packets to the AT. Upon receiving the DRC information, the AN utilizes the DRC information to coordinate packet scheduling and transmission format selection.

The Third Generation Partnership Project 2 (3GPP2), a wireless standards group, is presently developing next-generation wireless communication standards. In a harmonized framework proposal developed by members of 3GPP2, several different reverse control channels are defined. One of the reverse control channels in that proposal is a Reverse Channel Quality Indicator Channel (R-CQICH). The primary purpose of R-CQICH is to supply an AN with a Forward Link channel quality measure, for use in scheduling transmissions on a Forward Data Channel (F-DCH). R-CQICH is regularly transmitted by each AT to its respective Forward Link serving sector, cycling among active set members. A proposed minimum transmitting period of R-CQICH in the current harmonized framework proposal is 6 frames.

R-CQICH facilitates transmission of a control Channel Quality Indicator (CQI) report, to support channel quality feedback for Single Input Single Output (SISO) transmission. Furthermore, a control CQI report may indicate a desired Forward Link serving sector for Forward Link Layer 1 (L1) handoff. The control CQI report may also be used by Forward Link and Reverse Link serving sectors, and other members of the active set, for power controlling transmission of control information to an AT. Examples of control information messages may include Forward Link and Reverse Link assignment messages that are transmitted on the Forward Link Shared Control Channel (F-SCCH).

F-SCCH is used to allocate and schedule Forward Link and the Reverse Link resources for transmission, to specify respective packet formats used during transmission, and to grant access to users in an idle state. F-SCCH carries a number of control channel messages that allocate or de-allocate resources to and from a given AT, including Forward Link and Reverse Link assignment messages. Both Forward Link and Reverse Link assignment messages have a “persistent” (or “sticky”) bit. When the “persistent” bit is not set, the assignment message indicates that the resource assignment has a duration of only a single packet. In contrast, when the “persistent” bit is set, the assignment is known as a “persistent assignment”—indicating the resource assignment lasts until explicitly de-assigned, or the assignment is lost due to excessive packet failure(s).

One example of a common use for persistent resource assignments is Voice over IP (VoIP) service—where required resources are stable, and resource allocation does not need to be frequently updated. In VoIP, persistent resource assignment can greatly reduce the amount of overhead required, by eliminating frequent transmission of Forward Link and Reverse Link assignment messages on F-SCCH. However, when supporting VoIP service, it is possible for the Reverse Link to become a “bottleneck” in a system when a large number of ATs simultaneously transmit information to an AN—causing relatively high interference levels at an AN receiver. Interference levels at an AN receiver can be reduced by increasing reporting period duration (e.g., from 6 frames to 12 or 24 frames) for reverse control channels, such as R-CQICH.

In the harmonized framework proposal, R-CQICH can only be sent in a predefined CDMA control segment. Each successive CDMA control segment is separated by 6 frames. Therefore, as an example, the reporting period of R-CQICH may be increased from a minimum of 6 frames to 24 frames, to reduce interference levels at an AN receiver. However, an increased reporting period length for R-CQICH results in less accurate Forward Link channel quality information being provided by an AT to the AN, since the reports are sent less frequently.

For F-DCH transmissions, less accurate and less up-to-date regular CQI reporting might not pose a significant problem, since F-DCH can utilize the Hybrid Automatic Repeat Request (H-ARQ) process to compensate for errors caused by an inaccurate CQI report. However, for F-SCCH transmissions, which lack H-ARQ, it is probable that a control channel message carried on F-SCCH may be received erroneously by an AT, since F-SCCH may be power-controlled by an AN using the inaccurate CQI report. Moreover, since the control channel message contains information necessary for an AT to correctly demodulate and decode data packets carried on F-DCH, erroneous reception of F-SCCH will also result in packet error on F-DCH.

It would therefore be desirable to provide highly accurate, up-to-date control channel information, such as a CQI report, to an AN without significantly increasing interference levels at the receiver(s) of the AN.

### SUMMARY OF THE INVENTION

The present invention provides a system of methods and constructs by which highly accurate and timely control channel information is provided to an AN; to optimize power control and data packet transmission. The system of the present invention provides accurate control channel information (CCI) for an AN (having one or more receivers), in communication with an AT. The AT indicates packet failure to the AN when it fails to properly decode a packet, and also communicates an “irregular” channel quality information message upon failure to properly decode the packet, in addition to regularly scheduled channel quality information messages. The channel quality information messages usually include information regarding Forward Link channel quality. Depending upon the particular embodiment utilized, implementation may be in a code-division multiplexing system; such as known forms of non-standard CDMA, or specific standards such as cdma2000. Implementation may also be in an orthogonal frequency division multiplexing access (OFDMA) system.

According to the present invention, an AN and an AT are provided such that the AN transmits a data packet to the AT in accordance with a host wireless communication system. That data packet may not be properly decoded by the AT, which causes the AT to indicate a packet failure to the AN. This indication may comprise transmitting a negative acknowledgment (NACK) to the AN, across a reverse acknowledgment channel (R-ACKCH). Additionally, the AT communicates an irregular, or unscheduled, channel quality information message to the AN.

In certain embodiments of the present invention, an AT communicates a control channel information message in a next available control segment, based on a minimum reporting period. Since transmission of the control channel information is triggered by a packet error, the particular control channel information message may be defined as a Packet-Error-Triggered (PET) control channel information (CCI) message.

In other embodiments of the present invention, an AT may transmit or communicate a CCI message before a next available control segment. In fact, in some embodiments, an AT may communicate a PET-CCI message in the same frame where a Negative Acknowledgement (NACK) is transmitted to the AN. Similarly, in other embodiments of the present invention, upon receiving at least one packet error from an AN, an AT transmits a PET-CCI message in a frame later than the frame where the NACK is transmitted, but before transmission of F-SCCH and/or a next available control segment.

In certain embodiments, a PET-CCI message may contain the same type of information as contained in a regular, periodic, scheduled CCI message. However, in other embodiments, a PET-CCI message may contain a different type of information from those contained in regular control channel information messages. For example, a PET-CQI report may contain Forward Link channel quality measured over the same frequency band as a regular CQI report or scheduled CCI message. Alternatively, a PET-CQI report may contain Forward Link channel quality measured only over sub-carriers on which F-SCCH will be transmitted to an AT.

In other embodiments, a PET-CCI message may be transmitted using the same channel gain as that used for a regular, periodic CCI message. Alternatively, a PET-CCI message may be transmitted using channel gain higher than that used for regular, periodic CCI messages in order to improve its reliability at an AN receiver.

In accordance with other aspects of the present invention, methods to optimize performance of decoding Reverse Acknowledgement Channel (R-ACKCH) at an AN are provided. According to some embodiments of the present invention, an AN attempts to transmit a data packet to an AT, but the packet may not be properly decoded by the AT. Thus, the AT may transmit a NACK (such as on the R-ACKCH) and a PET-CCI message—an unscheduled CCI message—on a control channel (such as R-CQICH). In such embodiments an AN may determine that a packet is received unsuccessfully at the AT, if a NACK is detected on the R-ACKCH by the AN receiver. On the other hand, the AN may determine that the packet is received successfully at the AT if an ACK is detected on the R-ACKCH and/or there is no PET control channel information detected.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts.

FIG. 1 illustrates a PRIOR ART example of a timing diagram representing the timing relationship of the Forward Link packet transmissions, R-ACKCH transmissions, R-CQICH transmissions, and F-SCCH transmissions in a conventional wireless communication system;

FIG. 2 illustrates an example of a timing diagram representing the timing relationship of Forward Link packet transmission, R-ACKCH transmissions, R-CQICH transmissions, PET-CQI transmissions, and F-SCCH transmissions according to the present invention; and

FIG. 3 illustrates an example of a timing diagram representing the timing relationship of Forward Link packet transmission, R-ACKCH transmissions, R-CQICH transmissions, PET-CQI transmissions, and F-SCCH transmissions according to the present invention.

### DETAILED DESCRIPTION

The present invention provides unique methods and apparatus for sending timely and accurate control channel information to an AN to facilitate power control and data packet transmission on the forward link. It is understood, however, that the following disclosure provides many different embodiments, or examples, for implementing different features of the invention. Specific examples of components, signals, messages, protocols, and arrangements are described below to simplify the present disclosure. These are provided merely examples and are not intended to limit the invention from that claimed. Well known elements are presented without detailed description to avoid obscuring the present invention with unnecessary detail.

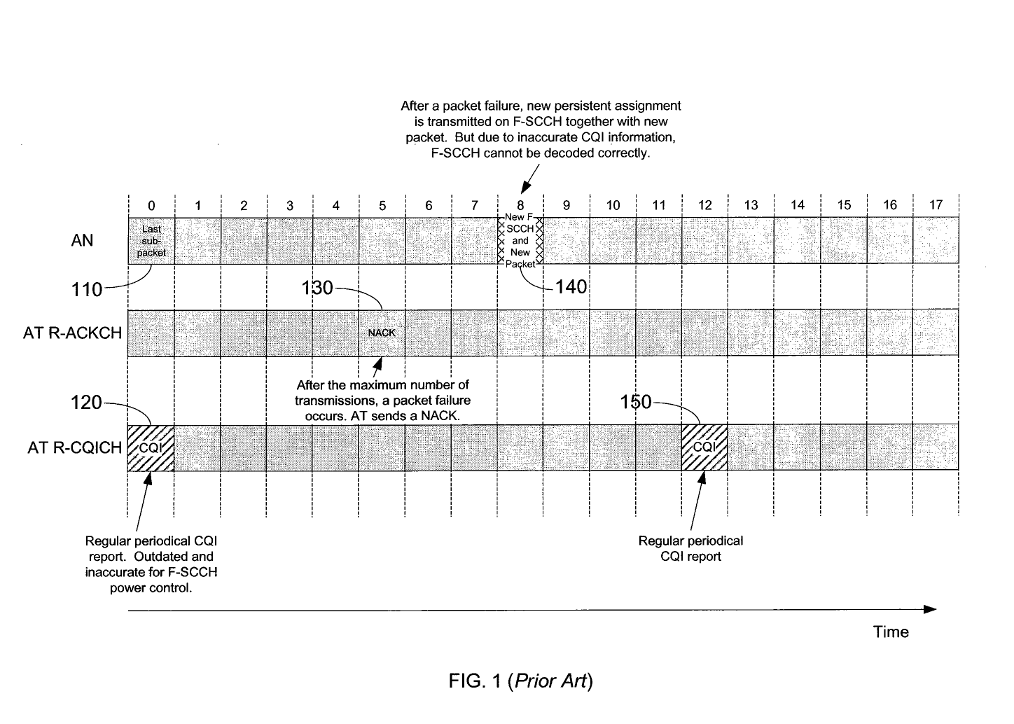

Referring first to FIG. 1, for purposes of illustration and explanation, a PRIOR ART timing diagram is provided—depicting the timing relationship between Forward Link packet transmissions, Reverse Link Acknowledgement Channel (R-ACKCH) transmissions, the Reverse Link Channel Quality Indicator Channel (R-CQICH) transmissions, and the Forward Link Shared Control Channel (F-SCCH) transmissions in a conventional wireless communication system. In Frame 0, an AN transmits last sub-packet 110 of a data packet to an AT. At the end of Frame 0, the AN has exhausted the maximum number of re-transmissions for the data packet. The AT receives the last sub-packet 110 and performs decoding of the data packet by combining the last sub-packet with previously received sub-packets associated with the same data packet. When the decoding is unsuccessful due to poor forward channel quality, a packet error occurs. After a packet error occurs, the AT sends a Negative Acknowledgement (NACK) 130 in Frame 5 to the AN, indicating the packet error.

According to the prior art system depicted in FIG. 1, the AT also sends regular Channel Quality Indicator (CQI) reports to the AN, identified as 120 and 150. The regular CQI reports are sent on the R-CQICH and occur periodically. Although depicted as every 12 frames in FIG. 1 for illustrative purposes, the CQI reporting period may be longer than 12 frames—such as 24 frames per CQI report—in an actual implementation.

Packet error at the AT causes a loss of persistent resource assignment. In order for the AN to transmit additional data packets to the AT, a new resource assignment is required. As shown in Frame 8 of FIG. 1, the AN sends a new resource assignment message 140 on F-SCCH with a new data packet on F-DCH, after receiving NACK from the AT. The new resource assignment message 140 contains information indicating the details of the resource used by F-DCH. In this system, F-SCCH is power-controlled by the AN using information contained in the CQI report 120 from the AT.

Due to the variation of channel conditions and the long delay between the last CQI report 120 and the current frame for new resource assignment message 140 and a pending data packet, the last CQI report 120 is outdated and inaccurate for purposes of power-controlling F-SCCH. This will likely result in yet another receiving error at the AT. Thus, both new resource assignment message 140 carried on F-SCCH and the data packet on F-DCH will be lost. These errors, together with the previous packet error, form an error burst, which will cause a significant degradation of voice quality in a VoIP system, when compared to effects of packet errors that are uniformly-distributed. Such packet error could also cause additional delay, as the Access Network must wait until a maximum number of re-transmissions has been attempted before transmitting more packets to the AT, which may have further negative impact on the quality of VoIP service.

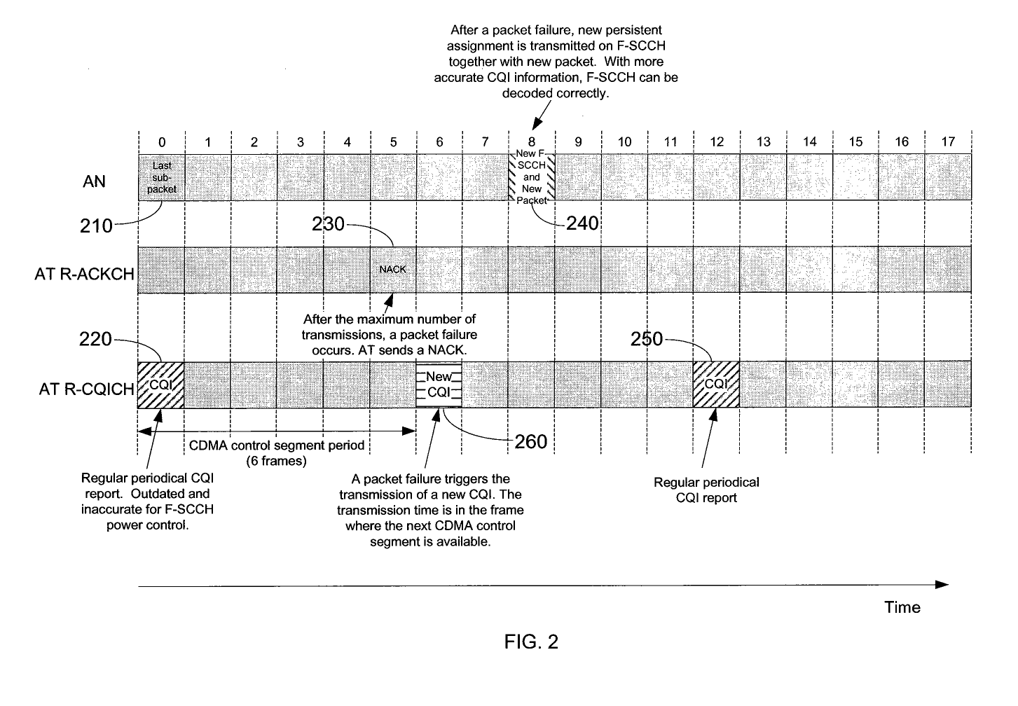

In contrast to the prior art illustration provided above, and in reference now to FIG. 2, an illustrative timing diagram according to the present invention is depicted. The timing diagram depicts timing relationships of Forward Link packet transmissions, R-ACKCH transmissions, R-CQICH transmissions, PET-CQI transmissions, and F-SCCH transmissions according to the present invention. In Frame 0, an AN sends a last sub-packet 210 of a data packet to an AT, while also exhausting a maximum number of transmissions for the data packet. The AT receives last sub-packet 210, and performs decoding of the data packet by combining the last sub-packet with previously received sub-packets. As before, decoding may be unsuccessful, causing a packet error. In such a case, the AT sends a Negative Acknowledgment (NACK) 230 in Frame 5 to the AN, indicating the packet error. In Frames 0 and 12, the AT sends regular CQI reports 220 and 250 on R-CQICH; which occur less frequently than the minimum reporting rate due to increased number of ATs and increased reporting period time.

Pursuant to the present invention, detection of a packet error causes the AT to send a CCI message 260 in a next available control segment, after or during the same frame wherein the NACK 230 is sent. The timing of the control segment is determined by, among other factors, minimum reporting period of the CQI report—which equals the CDMA control segment period. In the example shown in FIG. 2, the CDMA control segment period is 6 frames, so the control channel information 260 is sent in Frame 6. Since transmission of the control channel information 260 is triggered by the packet error, the control channel information 260 is referred to as Packet-Error-Triggered (PET) CCI. PET-CCI 260, according to some embodiments of the present invention, is an additional CQI report; complementing the regular CQI reports 220 and 250. This additional PET-CQI report may be referred to as an “irregular” or “intermittent” CQI report, in that it is not regularly scheduled to be sent from the AT to the AN.

A packet error at the AT will also cause loss of persistent resource assignment. In order for the AN to continue transmitting data packets to the AT, a new resource assignment is required. As depicted in FIG. 2, the AN sends a new resource assignment message 240 on F-SCCH with a new data packet on F-DCH in Frame 8, after the AN has received the NACK 230 and PET-CQI report 260 from the AT. Compared to the regular CQI reports 220 and 250, the PET-CQI report 260 provides up-to-date and accurate channel information to the AN, due to the short time difference between sending the PET CQI report 260 and the new resource assignment message 240 and data packet; which is only 2 frames instead of an 8 frame difference between a regular CQI report 220 and a new resource assignment message 240. Even longer periods between regular CQI reports (e.g., 24 frames) utilizing the new PET-CQI report 260 of the system of the present invention provide significant performance advantages over conventional systems.

With the present invention, timely and accurate channel information provided by PET-CQI report 260 enables an AN to power control F-SCCH more precisely, resulting in reliable reception of F-SCCH information at an AT. A new resource assignment message 240 contains information necessary for an AT to correctly demodulate and decode data packets carried on F-DCH; and thus reliable reception of F-SCCH provides successful, reliable reception of a data packet on F-DCH. This system reduces the occurrence and likelihood of error burst and delay for packet transmission—especially when used in conjunction with VoIP packet transmission—resulting in improved quality of voice service.

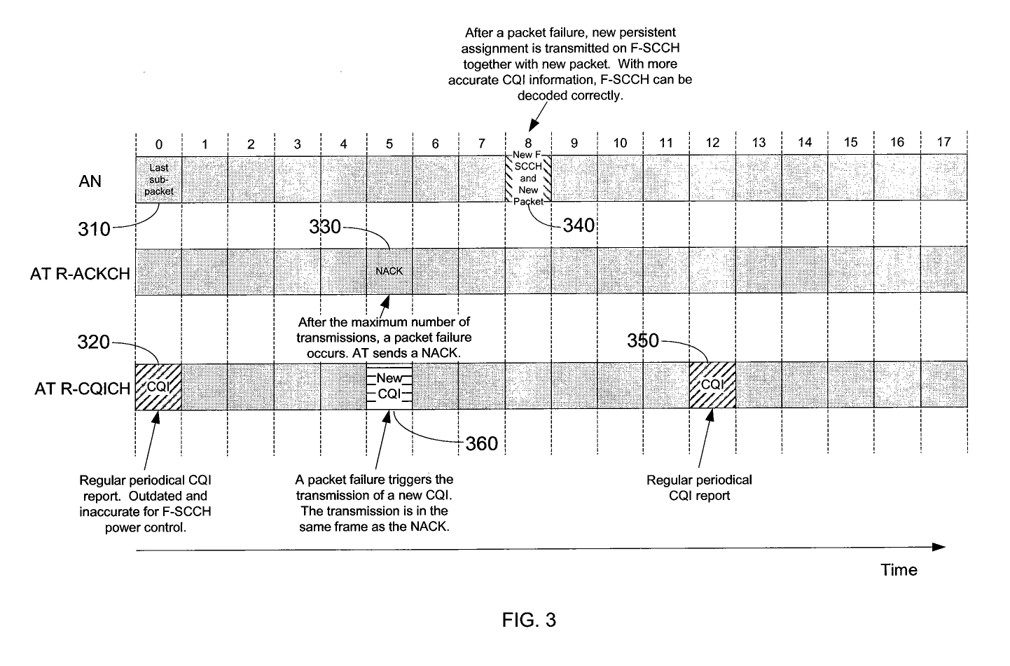

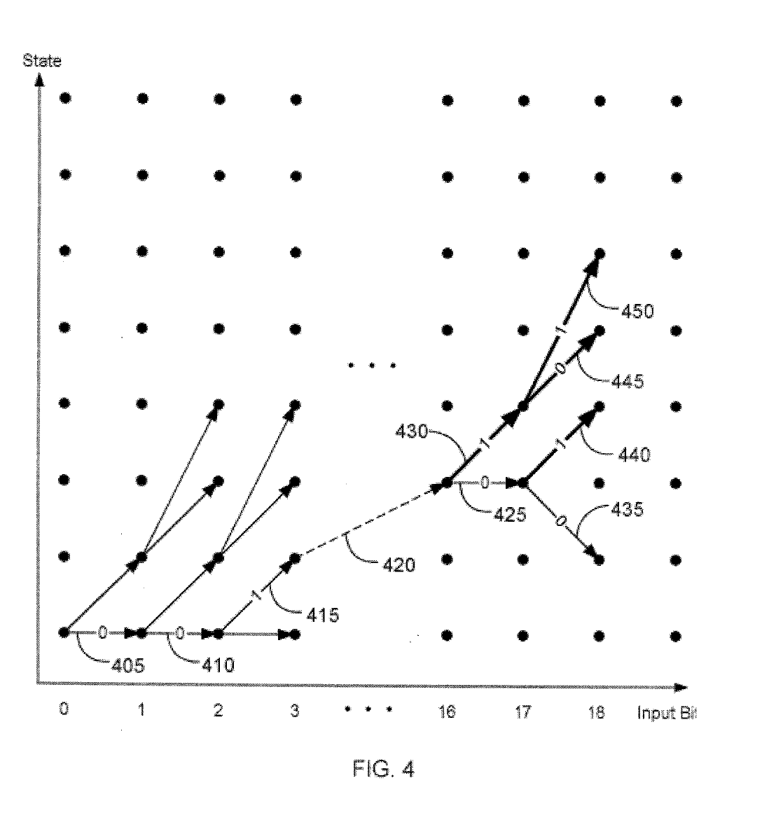

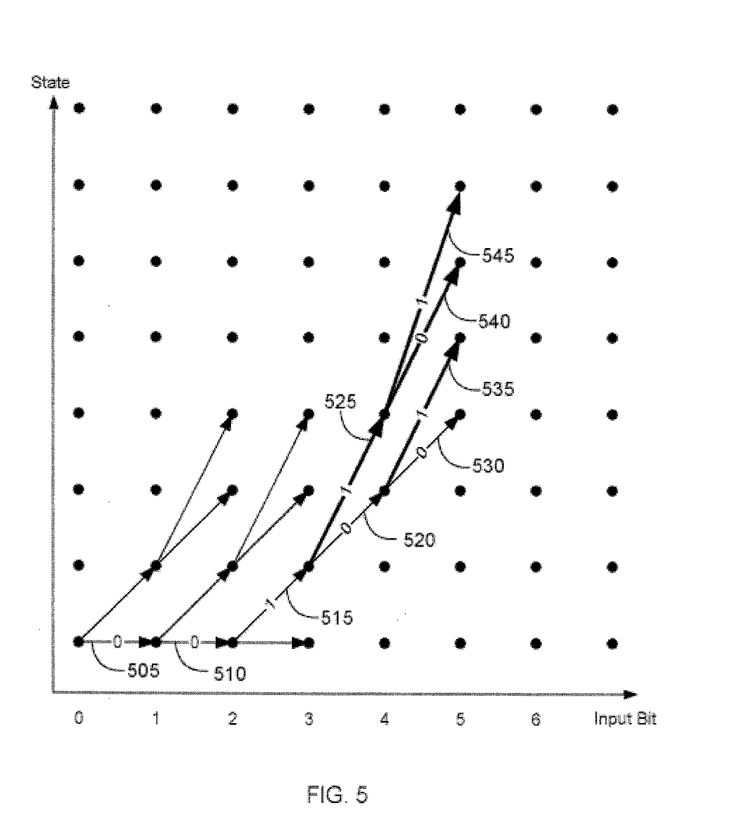

Another embodiment is comprehended; where an AT transmits a PET-CQI report in the same frame as a Negative Acknowledgment (NACK), as depicted now in FIG. 3. As depicted, the AT sends a NACK 330 in Frame 5 to an AN, after the AT detects a packet error. In this embodiment, the AT also sends new CCI, such as a new PET-CQI report 360, in the same frame as NACK 330. In this embodiment, the AT does not wait for a next available control segment to send new PET-CQI report 360—it sends both NACK 330 and PET-CQI report 360 simultaneously.

In view of the foregoing, other embodiments are also contemplated by the present invention. For example, an AT may transmit CCI in response to a packet error—such as a PET-CQI report—in any frame after the NACK is transmitted, but before transmission of F-SCCH. This embodiment may be applied to configurations where a standard control segment period is relatively long; resulting in unacceptable delay in waiting for a next available control segment.

In some embodiments of the present invention, PET-CQI reports contain the same types of information as contained in regular control channel information messages, or regular CQI reports. Alternatively, PET-CCI may contain a different set of information, or different types of information, as compared to the set of information contained in the regular CCI transmissions. For example, both an irregular PET-CQI report and a regular CQI report may contain data on Forward Link channel quality, measured over the same frequency bands. However, in other embodiments, an irregular PET-CQI report may only contain data on Forward Link channel quality measured over sub-carriers utilized by SCCH.

The present invention also contemplates that PET-CCI may be sent using the same channel gain as used for regular CCI, or CQI reports. However, in some embodiments, PET-CCI may be sent using a channel gain that is higher than the gain used for regular CCI, or regular CQI reports—which may significantly improve reliability at an AN receiver. It should be noted that additional overhead caused by the new PET-CCI is relatively small, since PET-CCI is only transmitted when a packet error occurs. For example, with a typical Packet Error Rate (PER) of 1%, PET-CCI will only be transmitted once every 100 packets.

In accordance with other aspects of the present invention, methods to optimize performance of decoding the Reverse Acknowledgement Channel (R-ACKCH) at an AN are disclosed. Upon receiving a packet error from an AN, an AT transmits a NACK on R-ACKCH and PET-CCI on another control channel, such as a PET-CQI report on R-CQICH. The AN determines that a data packet was received unsuccessfully at the AT if a NACK is detected on R-ACKCH. Conversely, the AN determines that the packet is received successfully at the AT if an ACK is detected on R-ACKCH, and there is no PET-CCI detected. If a packet error triggers transmission of a PET-CQI report, the probability of a NACK mistaken for an ACK at the AN receiver can be significantly reduced. Specifically, the probability of an erroneous detection of an ACK is reduced by a factor related to the likelihood of a PET-CQI not being detected. Therefore, the performance of proper decoding of R-ACKCH is enhanced, and overall system performance is improved.

The techniques disclosed in the present invention can be used in frequency-division multiplexing systems, time-division multiplexing systems, code-division multiplexing system, as well as orthogonal frequency division multiplexing access (OFDMA) system. The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of providing accurate control channel information in a communication system, comprising the steps of:
providing an access network and an access terminal;
transmitting a data packet from the access network to the access terminal;
indicating a data packet failure from the access terminal to the access network; and
communicating a control information message from the access terminal to the access network.

2. The method of claim 1, wherein the control information message is an irregular channel quality information message.

3. The method of claim 1, further comprising the step of:
communicating a plurality of regular channel quality information messages from the access terminal to the access network.

4. The method of claim 3, wherein the irregular channel quality information message and the regular channel quality information messages each contain a substantially identical set of information.

5. The method of claim 3, wherein the irregular channel quality information message and each of the regular channel quality information messages do not contain a substantially identical set of information.

6. The method of claim 3, wherein the irregular channel quality information message is sent at a higher power channel gain level than the plurality of regular channel quality information messages.

7. The method of claim 3, wherein the irregular channel quality information message is sent at the same power channel gain level than the plurality of regular channel quality information messages.

8. The method of claim 1, wherein the step of indicating a packet failure further comprises the step of transmitting a negative acknowledgment (NACK) from the access terminal to the access network.

9. The method of claim 1, wherein the step of indicating a packet failure further comprises the step of using a reverse acknowledgment channel (R-ACKCH) to indicate the packet failure.

10. The method of claim 1, wherein indicating the packet failure and communicating an irregular channel quality information message are performed simultaneously within a single frame.

11. The method of claim 1, further comprising the step of retransmitting a failed packet from the access network to the access terminal using information from the irregular channel quality information message.

12. The method of claim 1, further comprising the step of transmitting a new resource assignment message from the access network to the access terminal using information from the irregular channel quality information message.

13. The method of claim 12, wherein the step of transmitting a new resource assignment message further comprises using a forward link shared control channel (F-SCCH) to transmit the new resource assignment message.

14. The method of claim 1, further comprising the step of modifying a set of transmission parameters for communication from the access network to the access terminal using information from the irregular channel quality information message.

15. A method for detecting failed packet transmissions, the method comprising the steps of:
providing an access network and an access terminal;
attempting to transmit a data packet from the access network to the access terminal;
transmitting a positive acknowledgment (ACK) from the access terminal to the access network if the data packet is decoded properly at the access terminal;
transmitting a negative acknowledgment (NACK) from the access terminal to the access network if the data packet is not decoded properly at the access terminal; and
transmitting an unscheduled control channel information message from the access terminal to the access network if the data packet is not decoded properly at the access terminal;
wherein determining if the data packet was decoded properly comprises verifying that an unscheduled control channel information message was not received by the access network.

16. The method of claim 15, wherein determining the data packet was decoded properly further comprises the step of verifying a positive acknowledgment (ACK) from the access terminal was received at the access network.

17. The method of claim 15, wherein determining the data packet was decoded properly further comprises the step of verifying a negative acknowledgment (NACK) from the access terminal was not received at the access network.

18. A system for providing accurate control channel information in a wireless communications system, comprising:
an access network, having at least one access network receiver; and
an access terminal in communication with the access network;
wherein the access terminal is adapted to indicate a packet failure to the access network when the access terminal fails to properly decode a packet; and
wherein the access terminal is adapted to communicate a control information message to the access network when the access terminal fails to properly decode a packet.

19. The system of claim 18, wherein the access terminal is in communication with the access network using code-division multiplexing or orthogonal frequency division multiplexing.

20. The system of claim 18, wherein the access terminal indicates a packet failure by transmitting a negative acknowledgment (NACK) to the access network.

21. The system of claim 18, further comprising:
a second access terminal in communication with the access network, wherein the second access terminal indicates a packet failure to the access network when the second access terminal fails to properly decode a packet, and wherein the access terminal communicates a control information message to the access network when the second access terminal fails to properly decode a packet.
